(19) United States
(12) Patent Application Publication
(10) Pub. No.: US 2010/0112304 A1
(43) Pub. Date: May 6, 2010

(54) DISPERSE AZO DYE MIXTURES

(76) Inventor: Helmut Sieber, Rheinfelden (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/794,592

(22) PCT Filed: Dec. 31, 2005
(86) PCT No.: PCT/EP2005/057236

§ 371 Date: Jun. 29, 2007

(30) Foreign Application Priority Data
Jan. 4, 2005 (EP) 05100032.1

(51) Int. Cl. B32B 3/00; D06P 1/18; C09B 67/22; B05D 5/00

(52) U.S. Cl. 428/195.1; 8/696; 427/256

(57) ABSTRACT

Mixture comprising at least one compound of formula (I) and at least one compound of formula (II) where the substituents are each as defined in the claims, and use of these mixtures for colouring hydrophobic synthetic materials.

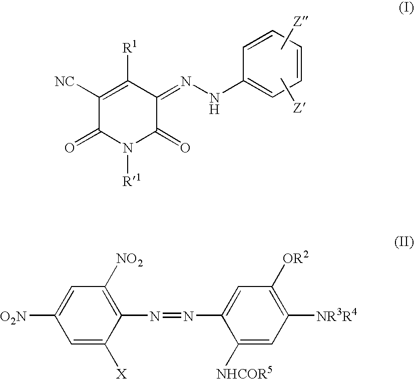

The invention relates to disperse azo dye mixtures, processes for their production and also their use for dyeing and printing hydrophobic synthetic materials.

It is an object of the present invention to provide navy to black disperse dye mixtures having good application properties.

We have found that this object is achieved by the use of a dye mixture comprising at least one dye of the formula (I)

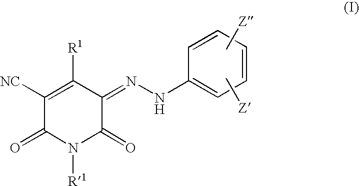

where

Z′ and Z″ are each independently hydrogen, halogen, CN or NO₂, and

R¹ and R′¹ are each independently hydrogen or unsubstituted C₁-C₄-alkyl or C₁-C₄-alkyl substituted by —OH, —CN, —OCOR, —OCOC₆H₅, —OCOOR, —COOR, —OC₆H₅, —C₆H₅ and/or C₁-C₄-alkoxy,

and at least one dye of the formula (II)

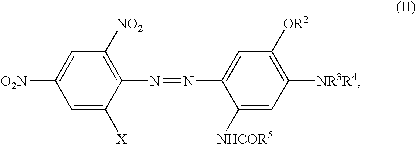

where

X is halogen, in particular Cl and Br or CN,

R² and R⁵ are each independently hydrogen or unsubstituted C₁-C₄-alkyl or C₁-C₄-alkyl substituted by —OH, —CN, —OCOR, —OCOC₆H₅, —OCOOR, —COOR, —OC₆H₅, —C₆H₅ and/or C₁-C₄-alkoxy,

R³ and R⁴ are each independently hydrogen, substituted C₁-C₄-alkyl or C₂-C₄-alkenyl, possible substituents for alkyl being preferably —OH, —CN, —OCOR, —OCOC₆H₅, —OCOOR, —COOR, —OC₆H₅, —C₆H₅ and/or C₁-C₄-alkoxy, where R is hydrogen or C₁-C₄-alkyl,

for dyeing polyester material.

This invention further relates to a dye mixture comprising at least one dye of the formula (I′)

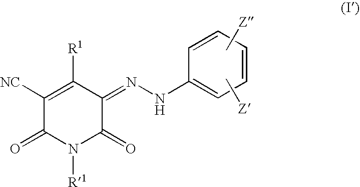

where

Z′ and Z″ are each independently hydrogen, halogen or CN, and

R¹ and R′¹ are each independently hydrogen or unsubstituted C₁-C₄-alkyl or C₁-C₄-alkyl substituted by —OH, —CN, —OCOR, —OCOC₆H₅, —OCOOR, —COOR, —OC₆H₅, —C₆H₅ and/or C₁-C₄-alkoxy,

and at least one dye of the formula (II)

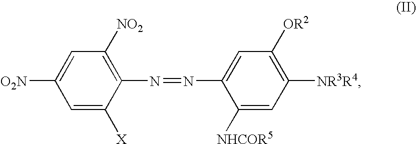

where

X is halogen, in particular Cl and Br or CN,

R² and R⁵ are each independently hydrogen or unsubstituted C₁-C₄-alkyl or C₁-C₄-alkyl substituted by —OH, —CN, —OCOR, —OCOC₆H₅, —OCOOR, —COOR, —OC₆H₅, —C₆H₅ and/or C₁-C₄-alkoxy,

R³ and R⁴ are each independently hydrogen, substituted C₁-C₄-alkyl or C₂-C₄-alkenyl, possible substituents for alkyl being preferably —OH, —CN, —OCOR, —OCOC₆H₅, —OCOOR, —COOR, —OC₆H₅, —C₆H₅ and/or C₁-C₄-alkoxy, where R is hydrogen or C₁-C₄-alkyl.

Both mixtures of dyes, either the dye mixture comprising a dye according to the formula (I) and a dye according to the formula (II) which is used in a process for dyeing polyester material and the dye mixture comprising a dye according to the formula (I′) and a dye according to the formula (II) may comprise further dyes according to the formulas (III), (IV) or (V) in the manner as described bellow.

By preference, when Z′ and Z″ signify halogen Z′ and Z signify Cl or Br; more preferably the halogen is Cl.

In preferred dyes of the formula (I) Z′ and Z″ are independently Cl or Br and R¹ and R′¹ are each independently hydrogen or unsubstituted C₁-C₄-alkyl.

The dyes of the formula (I) and (I′) are known and can be prepared by known methods. Particularly preferred dyes of the formula (I) is the dye of the formula (1a) or (1b) and the preferred dye of the formula (I′) is the dye of the formula (1a):

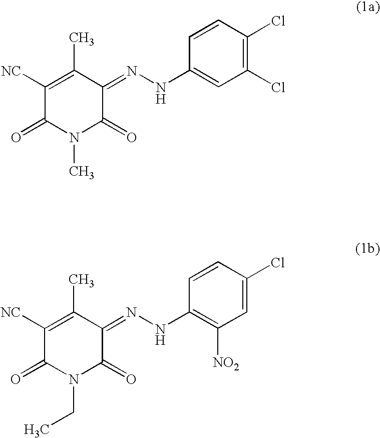

The dye of the formula (1a) is known as C.I. Disperse Yellow 241 and has CAS registry number 83249-52-9 and the C.I. Constitution Number C.I. 128450. The dye of the formula (1b) is known as C.I. Disperse Yellow 211 and has CAS registry number 70528-90-4 or 86836-02-4 and the C.I. Constitution Number C.I. 128470. The preparation of the dyes of formula (I), especially of the formula (1a) or the formula (1b) is known per se. The dyes of the formula (II) are known from DE-A-2 818 653 for example.

Preferred mixtures comprise a dye of formula (II) where X is halogen, especially Cl or Br. In particularly preferred dyes of formula (II) R³ and R⁴ are each independently hydrogen, C₂-C₄-alkenyl, unsubstituted C₁-C₄-alkyl or C₁-C₄-alkyl substituted by —OCOR, —CN and/or —COOR, where R is as defined above.

More particularly, in the formula (II), R² and R⁵ are each independently C₁-C₄-alkyl, preferably CH₃.

Particularly preferred mixtures comprise at least one dye of formula (I) and at least one dye of the formula (II) selected from the group consisting of (IIa) to (IIj):

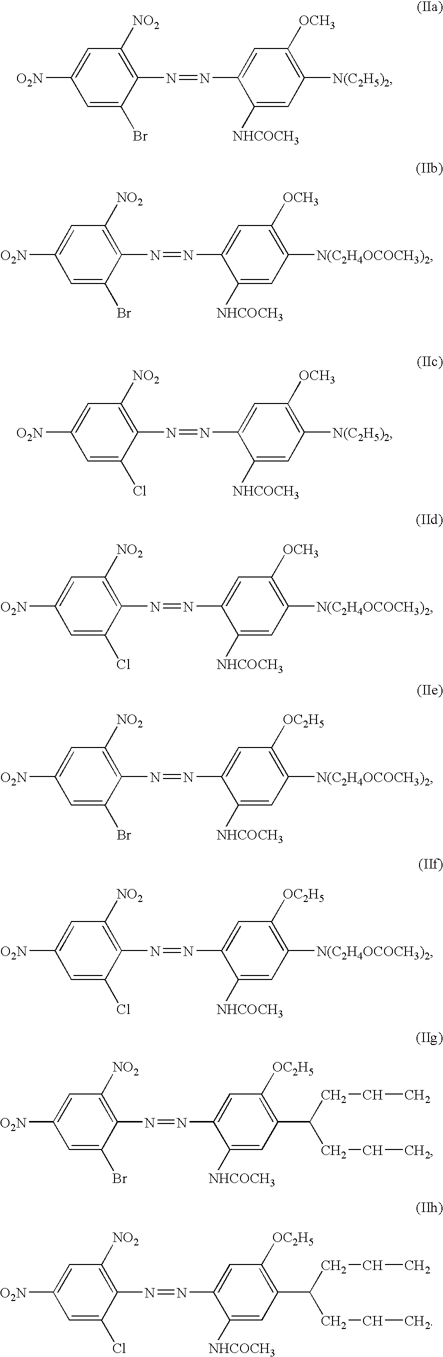

Particularly preferred mixtures comprise at least one dye of formula (I′) and at least one dye of the formula (II) selected from the group consisting of (IIa) to (IIj).

Preference is further given to mixtures according to the invention which further comprise a further dye of the formula (III); (IV) and/or (V),

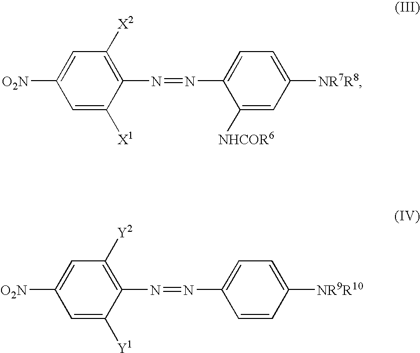

and/or

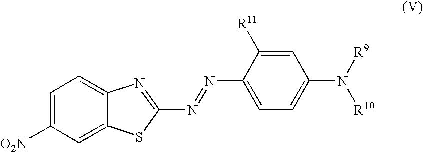

where

X¹ is halogen, especially Cl and Br or CN,

X² is halogen, especially Cl and Br, hydrogen, NO₂ or CN,

R⁶ is C₁-C₄-alkyl,

R⁷ and R⁸ are each independently hydrogen, unsubstituted or —OH—, —CN—, —OCOR—, —OCOC₆H₅—, —OCOO(C₁-C₄-alkyl)-, —COOR—, —OC₆H₅—, —C₆H₅— and/or C₁-C₄-alkoxy-substituted C₁-C₄-alkyl or C₂-C₄-alkenyl, where R is as defined above,

Y¹ and Y² are each independently hydrogen or halogen, especially Cl and Br or —CN,

R⁹ and R¹⁰ are each independently hydrogen, unsubstituted or —OH—, —CN—, —OCOR—, —OCOC₆H₅— and/or C₁-C₄-alkoxy-substituted C₁-C₄-alkyl, where R is as defined above, or C₂-C₄-alkenyl,

R¹¹ is hydrogen, C₁-C₄-alkyl or C₁-C₄-alkoxy.

Particularly preferred mixtures, as well as the dyes of the formulae (I) and (II), further comprise a dye of the formula (III).

Particularly preferred mixtures, as well as the dyes of the formulae (I′) and (II), further comprise a dye of the formula (III).

Suitable are in particular dyes of the formula (III) selected from the group consisting of (IIIa) and (IIIb):

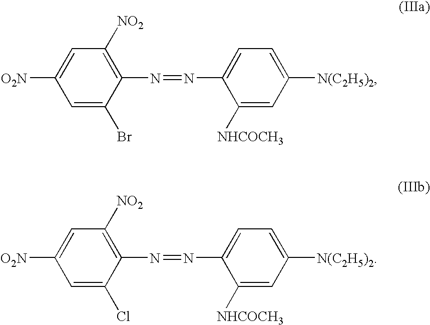

Likewise particularly preferred mixtures, as well as the dyes of the formulae (I) and (II), further comprise a dye of the formula (IV). Likewise particularly preferred mixtures, as well as the dyes of the formulae (I′) and (II), further comprise a dye of the formula (IV). Suitable in particular are dyes of the formula (IV) which conform to the formula (IVa):

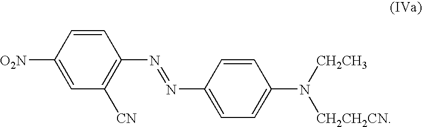

Particularly preferred mixtures further include those which, as well as the dyes of the formulae (I) and (II), further comprise a dye of the formula (V), in particular the dye of the formula (Va).

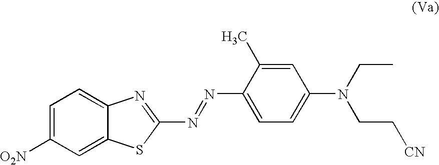

Further particularly preferred mixtures further include those which, as well as the dyes of the formulae (I′) and (II), further comprise a dye of the formula (V), in particular the dye of the formula (Va).

Very particularly preferred dye mixtures, as well as the dyes of the formulae (I) and (II), further comprise a dye of the formula (III) and a dye of the formula (IV).

Further, very particularly preferred dye mixtures, as well as the dyes of the formulae (I′) and (II), further comprise a dye of the formula (III) and a dye of the formula (IV).

Preferably, the dye mixture according to the invention comprises 1% to 99% and preferably 1% to 80% by weight and especially 5% to 60% by weight of at least one dye of the formula (I) and 1% to 99%, preferably 5% to 60% by weight and especially 5% to 40% by weight of at least one dye of the formula (II), based on the total amount of dye and provided that, that the sum based on the total amount of dye is 100%. A further preferred mixture comprises at least one dye of the formula (I′) instead of the at least one dye of the formula (I) and at least one dye of the formula (II).

Preferably, the dye of the formula (III) is used in an amount of 0% to 80% and especially 10% to 60% by weight, based on the total amount of dye.

Preferably, the dye of the formula (IV) is used in an amount of 0% to 40% and especially 5% to 30% by weight, based on the total amount of dye.

Preferably, the dye of the formula (V) is used in an amount of 0% to 40% and especially 5% to 30% by weight, based on the total amount of dye.

The dye mixtures according to the invention lead in particular in the above-indicated mixing ratios to black to navy shades.

The mixture according to the invention is notable in particular for excellent sublimation fastness and good exhaustion. Moreover, the colour yield is consistent over a wide pH range. They are particularly useful for alkaline dyeing of polyester, in particular at a pH of 8 to 11. The polyester-elastane blend fabrics dyed with the mixture of the invention are notable in particular for excellent wash fastness. The polyester-elastane blend of fabrics dyed with the mixture of the invention do not stain adjacent nylon fabric, in particular nylon-6,6, and acetate. Nor do the polyester-elastane blend fabrics dyed with the mixtures of the invention acquire a yellow tinge after repeated washing. Substrates dyed with the mixture of the invention exhibit excellent fastness under the conditions of the ISO 105/C06 wash at 50° C. and also when subjected to the ISO 105/C06 wash at 60° C. The mixtures of the invention are notable for high build-up capacity, which leads to very deep dark shades, in particular to a deeper black.

The dye mixture of the invention may also comprise further disperse dyes.

The invention further provides a process for producing the mixture of the invention, characterized in that the individual dyes (I) and (III) and optionally further dyes of the dye mixture are ground in water in the presence of a dispersant, subsequently mixed and optionally dried, or in that the dyes (I), (II) and optionally further ones are ground in water in the presence of a dispersant and optionally dried.

Dye mixtures according to the invention which are composed of the dyes of the formulae (I), (II) and also if appropriate one or more of the dyes of the general formulae (III) to (V) can be produced for example by simply mixing the components. The mixing can be effected by mixing separately finished individual components in the dyeing liquor, or else, preferably, by the presscakes of the individual components being mixed and conjointly finished.

The finish is characterized in that the dyes are converted by a grinding operation in the presence of a dispersant into an aqueous dispersion, i.e. into a liquid dye formulation or, after drying, into a pulverulent dye formulation, for which the individual dyes can first be separately finished and then mixed or the individual dyes first mixed and then conjointly finished. This grinding is preferably accomplished in mills, such as for example ball, swing, bead or sand mills, or in kneaders. After grinding, the size of the dye particles is preferably about 0.1 to 10 micrometres, in particular about 1 micrometre. The grinding is preferably effected in the presence of dispersants, which can be nonionic or anion active. Nonionic dispersants are for example reaction products of alkylene oxides, such as for example ethylene oxide or propylene oxide with alkylatable compounds, such as for example fatty alcohols, fatty amines, fatty acids, phenols, alkylphenols and carboxamides. Anion-active dispersants are for example ligninsulphonates and salts thereof, alkyl- or alkylarylsulphonates, alkylaryl polyglycol ether sulphates, alkali metal salts of the condensation products of naphthalenesulphonic acids and formaldehyde, polyvinylsulphonates and ethoxylated novolacs.

The invention accordingly also provides dye formulations comprising

10% to 60% by weight of the dye mixture of the invention, and

40% to 90% by weight of dispersant.

The dye formulations can be present in liquid or solid form, in which case the liquid formulations are preferably aqueous dye dispersions and the solid formulations are present as a powder or granules.

Preferred aqueous dye formulations comprise water,

15% to 50% by weight of the dye mixture of the invention, and

10% to 25% by weight of dispersant, all based on the dye formulation.

The abovementioned nonionic and anionic dispersants are preferred dispersants.

The dye formulations of the present invention may also comprise further auxiliaries, for example those which act as oxidizing agents, such as for example sodium m-nitrobenzenesulphonate, or fungicidal agents, such as for example sodium o-phenylphenoxide and sodium pentachlorophenoxide. Wetting agents, antifreeze agents, dustproofing agents or hydrophilicizing agents may also be present.

There are certain application sectors where solid formulations such as pulverulent or granular brands are preferred. Preferred solid dye formulations comprise

30% to 50% by weight of the dye mixture of the invention, and

70% to 50% by weight of dispersant.

They may further comprise if appropriate auxiliaries, such as for example wetting, oxidizing, preserving and dustproofing agents.

A preferred process for producing solid dye formulations consists in the above-described liquid dye formulations being stripped of their liquid, for example by vacuum drying, freeze drying, by drying on drum dryers, but preferably by spray drying.

Dye mixtures of the invention, however, are preferably also producible by conjoint finishing of the mixing components.

To this end, the mixing components are dispersed in water by a grinding operation in a suitable mixing ratio as described above and if appropriate converted into a solid dye formulation by removing the water.

To improve the properties of the dye formulations, it can be advantageous to subject the mixing components to a heat treatment before grinding. The heat treatment is carried out at 25 to 98° C., preferably at 30 to 80° C. and more preferably at 40 to 60° C. It is advantageous to follow the heat treatment directly, without intervening isolation, by a finishing operation, i.e. conversion into the commercial solid or liquid formulations. For this purpose, the heat-treated suspension is converted into a dispersion by grinding. It is advantageous for the heat treatment to be carried out in the presence of those dispersing and also, if appropriate, auxiliary agents which are to be present in the finished solid or liquid formulation. These are identical to the abovementioned surface-active substances. If the total amount of these dispersing and auxiliary agents was not added during the heat treatment, then the remainder is added prior to grinding. In this case, the amount of surface-active substances added for the heat treatment is generally in the range from 10% to 400% by weight and preferably in the range from 20% to 200% by weight, based on the dye mixtures.

To prepare the dyeing liquors, the requisite amounts of the dye formulations which were prepared in accordance with the above directions are diluted with the dyeing medium, preferably with water, to such an extent that a liquor ratio in the range from 5:1 to 50:1 results for the dye. In addition, further dyeing auxiliaries, such as carriers, dispersing and wetting agents are generally added to the liquors.

If the dye mixture of the invention is to be used for textile printing, then the requisite amounts of the dye formulation are preferably kneaded together with thickeners, such as for example alkali metal alginates or the like, and if appropriate further additives, such as for example fixation accelerants, wetting agents and hydrating agents to form printing pastes.

The dye mixtures of the invention, which may incidentally comprise still further dyes, are exceedingly suitable for dyeing and printing hydrophobic synthetic materials. Useful hydrophobic synthetic materials include for example: secondary cellulose acetate, cellulose triacetate, polyamides and high molecular weight polyesters. Preferably, the dye mixtures of the invention are used for dyeing and printing materials composed of high molecular weight polyesters, in particular those based on polyethylene glycol terephthalates or their blends with natural fibre materials, such as in particular wool or cellulose, or materials composed of cellulose triacetate. The dye mixtures of the invention are very particularly suitable for dyeing and/or printing polyester-polyurethane union fabrics and polyester-polyurethane blend fibre fabrics.

The preferred substrate when applying mixtures comprising at least one dye of the formula (I) and at least one dye of the formula (II) as well as a mixture comprising at least one dye of the formula (I′) and at least one dye of the formula (II) is polyester material, preferably polyester fibres especially preferably polyester fibres fabrics.

The hydrophobic synthetic materials can be present in the form of sheet- or threadlike structures and have been processed for example into yams or woven, loop-formingly knitted or loop-drawingly knitted textile materials. The hydrophobic synthetic materials can be present in the form of a non-woven. The dyeing of the fibre material mentioned with the dye mixtures of the invention can be effected in a conventional manner, preferably from an aqueous dispersion, if appropriate in the presence of carriers, between 80 to about 110° C. by the exhaust process or by the HT process in a dyeing autoclave at 110 to 140° C., and also by the so-called thermofixing process in which the fabric is padded with the dyeing liquor and then fixed/set at about 180 to 230° C. The printing of the materials mentioned can be carried out in a conventional manner by incorporating the dye mixtures of the invention into a printing paste and treating the fabric printed therewith with HT steam or dry heat at temperatures between 180 to 230° C., if appropriate in the presence of a carrier, to fix the dyes. This provides very strong olive, navy or black, in particular strong navy or black, dyeings and prints having very good fastnesses, in particular having very good light, rub, thermofixing, wash, water and sublimation fastnesses. The customary dyeing processes with which the dye mixtures of the invention can be dyed and/or printed are described for example in M. Peter and H. K. Rouette: “Grundlagen der Textilveredelung; Handbuch der Technologie, Verfahren and Maschinen”, thirteenth, revised edition, 1989, Deutscher Fachverlag GmbH, Frankfurt am Main, Germany, ISBN 3-87150-277-4, in which the following pages are particularly relevant: the pages 460-461, 482-495, 556-566 and 574-587.

The dye mixtures of the invention exhibit excellent wetting characteristics when making up dyeing and padding liquors and also printing pastes, and are rapidly dispersible without costly and inconvenient manual or mechanical stirring. The liquors and printing pastes are homogeneous and are easy to process in state of the art dyehouse drugstores without plugging the nozzles.

The liquid formulations of the invention have no tendency to phase separate and in particular no tendency to sediment and form a sticky deposit. There is thus no need for a similarly costly and inconvenient homogenization of the dye in the container prior to dye removal.

The millbase obtained in the production of solid formulations after grinding of the dyes in the presence of dispersing and auxiliary agents is stable at elevated temperature and for a prolonged period. The millbase does not need to be cooled in the mills or after removal from the mills and can be stored in collecting vessels for a prolonged period prior to spray drying.

The thermal stability of the dye mixture of the invention is also apparent from the fact that the spray-drying operation can be carried out at high temperatures without the material which is to be dried undergoing agglomeration. For a given dryer exit temperature, a higher entry temperature results in higher dryer performance and thus in lower manufacturing costs.

The dye formulations described above are very advantageously useful for making up printing pastes and dye liquors. They offer particular advantages for example in relation to the continuous processes where the dye concentration of the dyeing liquors has to be kept constant by continuously feeding dye into the running apparatus.

The advantage of the dye mixtures of the invention is particularly distinct when dyeing from an aqueous dyebath under state of the art commercial conditions.

State of the art commercial conditions are characterized by high pack densities in package and beam dyeings, short liquor ratios, i.e. high dye concentrations, and also high shearing forces in the dyeing liquor due to high pumping power. Even under these conditions, the dye mixtures of the invention do not tend to agglomerate, and do not filter out on the textile materials to be dyed. The dyeings obtained are accordingly homogeneous and have no colour strength differences between the outer and the inner coils of the wound packages, and the dyeings are free of any deposits. Pad dyeings and prints with the dye mixture of the invention produce a homogeneous, speckle-free appearance.

The dye mixtures of the invention are also useful for dyeing the above-recited hydrophobic materials from organic solvents by known solvent-dyeing methods and for mass coloration.

The invention therefore also provides for the use of the dye mixtures of the invention for dyeing and printing hydrophobic synthetic materials, in particular fibre materials and also for mass coloration of hydrophobic synthetic materials.

The above mentioned dyeing processes and processes of production are applicable either for a mixture comprising at least one dye of the formula (I) and at least one dye of the formula (II) as well as a mixture comprising at least one dye of the formula (I′) and at least one dye of the formula (II).

The examples which follow illustrate the invention. Parts and % in the description, examples and claims are by weight, unless otherwise stated.

### EXAMPLES

### Example 1

a) 12.9 g of the dye of the formula (1)

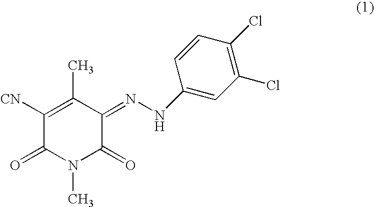

and 7.8 g of the dye of the formula (2)

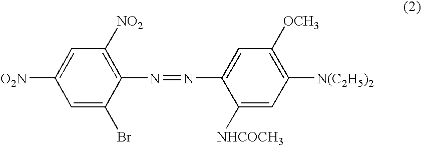

and also

20.6 g of the dye of the formula (3)

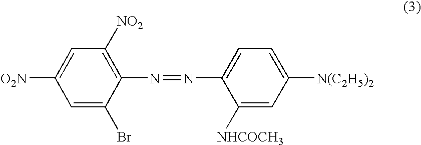

and

5.1 g of the dye of the formula (4)

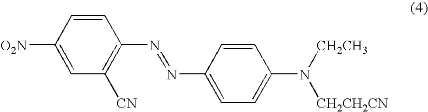

were bead or sand milled together with 300 ml of water and 53 g of a ligninsulphonate (sodium salt) for 3 hours and subsequently spray dried (entry temperature 130° C., exit temperature 60° C.). The powder thus obtained (about 100 g) has a residual moisture content of about 0.7% by weight and is readily dispersible in water.

b) 0.4 g of the powder prepared above was treated together with 10 g of polyester textile material at pH 4.5 and 130° C. according to a standard HT dyeing process for about 60 min. After washing, rinsing and drying, a deep black dyeing having very good fastnesses is obtained.

Further dye mixtures were produced similarly to Example 1 and used for polyester dyeing by using 13.3 g of dye 1 of Example 1 and 11 g of the dye of the general formula (II) in which the substituents have the meanings indicated in Table 1.

TABLE 1
Dye used of formula (II)

| Ex. | X | R² | R⁵ | R³ | R⁴ |
|---|---|---|---|---|---|
| 2 | Cl | C₂H₅ | C₂H₅ | CH₂CH₂CN | CH₂CH₂COOCH₃ |
| 3 | Br | CH₃ | CH₃ | CH₂CH₂—OCH₃ | CH₂CH₂—OCH₃ |
| 4 | Br | CH₃ | C₂H₅ | CH₂CH₂—OCOC₆H₅ | CH₂CH₂—OCOC₆H₅ |
| 5 | Br | CH₃ | CH₃ | CH₂CH₂—OCOCH₃ | CH₂CH₂—OCOCH₃ |
| 6 | Br | CH₃ | CH₃ | CH₂CH₂CN | CH₂—C₆H₅ |
| 7 | Cl | CH₃ | C₂H₅ | CH₂CH₂CN | H |
| 8 | Br | CH₃ | CH₃ | CH₂CH₂COOCH₃ | CH₂CH₂COOCH₃ |

### Example 9

5 g of the dye of the formula (1) and 39 g of the dye of the formula (5)

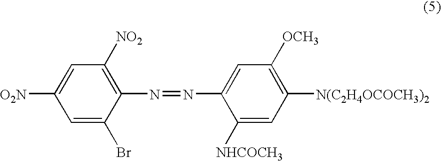

were ground and dried similarly to Example 1. The ligninsulphonate (sodium salt) was used in the same ratio based on the total amount of dye as in Example 1. The dye mixture obtained (0.1 g) was subsequently used for dyeing 10 g of polyester fibres to obtain bright navy dyeings having good wash and sublimation fastnesses.

The following dyes of the formulae (1) and II were combined according to Table 2 similarly to Example 9. The weight ratio of (1):II of Example 9 was retained (5 g of the dye of the formula (1) and 39 g of the dye of the formula (II) according to Table 2). Greenish to reddish navy dyeings were obtained.

TABLE 2
Dye of formula (II)

| Ex. No. | X | R² | R⁵ | R³ | R⁴ |
|---|---|---|---|---|---|
| 10 | Cl | CH₃ | CH₃ | CH₂—CH₂OCOCH₃ | CH₂CH₂OCOCH₃ |
| 11 | Cl | C₂H₅ | CH₃ | CH₂CH₂OCOCH₃ | CH₂CH₂OCOCH₃ |
| 12 | Br | C₂H₅ | CH₃ | CH₂CH₂OCOCH₃ | CH₂CH₂OCOCH₃ |
| 13 | Cl | CH₃ | CH₃ | C₂H₅ | C₂H₅ |
| 14 | Br | CH₃ | CH₃ | C₂H₅ | C₂H₅ |
| 15 | Cl | CH₃ | CH₃ | CH₂—CH═CH₂ | CH₂—CH═CH₂ |
| 16 | Br | CH₃ | CH₃ | CH₂—CH═CH₂ | CH₂—CH═CH₂ |
| 17 | Br | CH₃ | CH₃ | CH₂—CH═CH₂ | H |
| 18 | Cl | CH₃ | CH₃ | CH₂—CH═CH₂ | H |
| 19 | Br | C₂H₅ | CH₃ | C₂H₅ | C₂H₅ |
| 20 | Cl | C₂H₅ | CH₃ | C₂H₅ | C₂H₅ |
| 21 | Cl | CH₃ | CH₃ | CH₂CH₂OCOC₂H₅ | CH₂CH₂OCOC₂H₅ |
| 22 | Br | CH₃ | CH₃ | CH₂CH₂OCOC₂H₅ | CH₂CH₂OCOC₂H₅ |

### Example 23

24 g of the dye of the formula (1) of Example 1 and 7 g of the dye of the formula (3) of Example 1 and also 22 g of the dye of the formula (5)

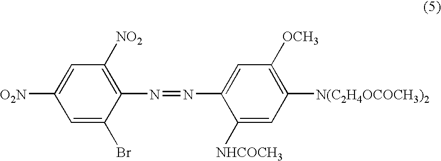

were ground together with 300 g of water and 53 g of sodium ligninsulphonate, and dried, similarly to Example 1.

When 0.35 g of this dye mixture is used for dyeing polyester fabric similarly to Example 1b good black dyeings are obtained.

When the dye of the formula (5) of Example 23 was replaced by the same amount of a dye of the formula (II) according to Table 3 hereinbelow, further black dyeings were obtained of polyester with good fastnesses.

TABLE 3
Substituent meanings for dye of formula (II)

| Ex. No. | X | R² | R⁵ | R³ | R⁴ |
|---|---|---|---|---|---|
| 24 | Cl | CH₃ | CH₃ | C₂H₄OCOCH₃ | C₂H₄OCOCH₃ |
| 25 | Br | C₂H₅ | CH₃ | C₂H₄OCOCH₃ | C₂H₄OCOCH₃ |
| 26 | Cl | C₂H₅ | CH₃ | C₂H₄OCOCH₃ | C₂H₄OCOCH₃ |
| 27 | Br | CH₃ | C₂H₅ | C₂H₄OCOCH₃ | C₂H₄OCOCH₃ |
| 28 | Cl | CH₃ | C₂H₅ | C₂H₄OCOCH₃ | C₂H₄OCOCH₃ |
| 29 | Br | CH₃ | CH₃ | C₂H₄OCOC₂H₅ | C₂H₄OCOC₂H₅ |
| 30 | Cl | CH₃ | CH₃ | C₂H₄OCOC₂H₅ | C₂H₄OCOC₂H₅ |
| 31 | Cl | CH₃ | CH₃ | C₂H₄COOCH₃ | C₂H₄COOCH₃ |
| 32 | Br | CH₃ | CH₃ | C₂H₄CN | C₂H₄CN |
| 33 | Br | CH₃ | CH₃ | C₂H₄OCH₃ | C₂H₄OCH₃ |
| 34 | Cl | CH₃ | CH₃ | C₂H₄CN | CH₂C₆H₅ |

### Example 35

17.6 g of the dye of formula (1), 9.4 g of the dye of formula (2) of Example 1 and 11.0 g of dye (3) of Example 1 were ground together with 62 g of sodium ligninsulphonate and 300 g of water, and dried, similarly to Example 1.

0.6 g of the powder thus obtained was dyed together with 10 g of polyester fabric at pH 8.5 to 9 by means of a glycine/NaOH buffer at 130° C. 60 min. A deep black textile material is obtained.

When the dye of the formula (2) in Example 35 was replaced by a dye of the formula (II) of Table 4 hereinbelow, in an equal amount, and these mixtures were used to dye polyester similarly to Example 35, deep black dyeings were likewise obtained.

TABLE 4
Dye components used of formula (II)

| Ex. No. | X | R² | R⁵ | R³ | R⁴ |
|---|---|---|---|---|---|
| 36 | Cl | CH₃ | CH₃ | C₂H₅ | C₂H₅ |
| 37 | Br | C₂H₅ | CH₃ | C₂H₅ | C₂H₅ |
| 38 | Cl | C₂H₅ | CH₃ | C₂H₅ | C₂H₅ |
| 39 | Cl | CH₃ | CH₃ | CH₂—CH═CH₂ | CH₂—CH═CH₂ |
| 40 | Br | CH₃ | CH₃ | CH₂—CH═CH₂ | CH₂—CH═CH₂ |
| 41 | Cl | CH₃ | CH₃ | CH₂—CH═CH₂ | H |
| 42 | Br | CH₃ | CH₃ | CH₂—CH═CH₂ | H |
| 43 | Cl | C₂H₅ | CH₃ | CH₂—CH═CH₂ | CH₂—CH═CH₂ |
| 44 | Br | C₂H₅ | CH₃ | CH₂—CH═CH₂ | CH₂—CH═CH₂ |
| 45 | Cl | CH₃ | C₂H₅ | CH₂—CH═CH₂ | CH₂—CH═CH₂ |
| 46 | Br | CH₃ | C₂H₅ | CH₂—CH═CH₂ | CH₂—CH═CH₂ |
| 47 | Cl | CH₃ | C₂H₅ | C₂H₅ | C₂H₅ |
| 48 | Br | CH₃ | C₂H₅ | C₂H₅ | C₂H₅ |

### Example 49

Polyester fabric was dyed similarly to Example 1 with a dye mixture comprising 16.7 g of the dye of the formula (1), 6.1 g of the dye of the formula (7)

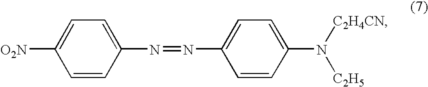

1.9 g of the dye of the formula (8)

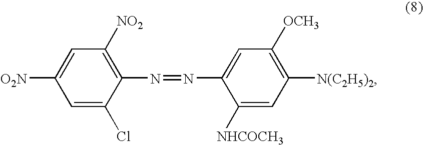

and

15.3 g of the dye of the formula (9)

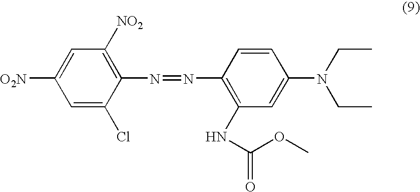

This mixture was bead milled in the presence of 50 g of sodium ligninsulphonate and 650 g of water and spray dried. 0.1 g of this mixture was used for dyeing 5 g of polyester fabric. Black dyeings are obtained.

### Examples 50 to 54

The mixtures of Table 5 hereinbelow were used for dyeing similarly to Example 48. Good pH dependency, excellent bath exhaustion and good sublimation fastness are obtained as results in all cases.

TABLE 5

| | | | Dye (II) | | | | Dye (III) | | | |
|---|---|---|---|---|---|---|---|---|---|---|
| Ex. No. | Dye (1) | Dye (7) | X | R² | R³ = R⁴ | R⁵ | X¹ | X² | R⁷ = R⁸ | R⁶ |
| 50 | ″ | ″ | Cl | CH₃ | CH₂CH═CH₂ | CH₃ | Cl | NO₂ | C₂H₅ | CH₃ |
| 51 | ″ | ″ | Cl | C₂H₅ | C₂H₅ | C₂H₅ | Cl | NO₂ | C₂H₅ | CH₃ |
| 52 | ″ | ″ | Br | CH₃ | C₂H₅ | CH₃ | Br | NO₂ | C₂H₅ | CH₃ |
| 53 | ″ | ″ | Cl | CH₃ | C₂H₅ | CH₃ | Br | NO₂ | C₂H₅ | CH₃ |
| 54 | ″ | ″ | Br | CH₃ | CH₂CH═CH₂ | CH₃ | Br | NO₂ | C₂H₅ | CH₃ |

1. Use of a mixture comprising at least one compound of the formula (I) 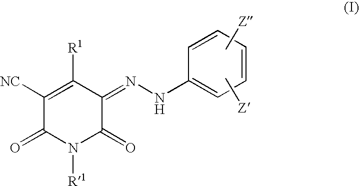
where
Z′ and Z″ are each independently hydrogen, halogen, CN or NO₂, and
R¹ and R′¹ are each independently hydrogen or unsubstituted C₁-C₄-alkyl or C₁-C₄-alkyl substituted by —OH, —CN, —OCOR, —OCOC₆H₅, —OCOOR, —COOR, —OC₆H₅, —C₆H₅ and/or C₁-C₄-alkoxy,
and at least one compound of the formula (II) 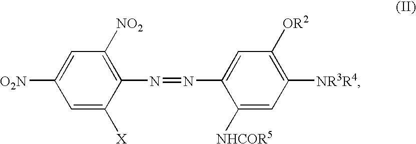
where
X is halogen, in particular Cl and Br or CN,
R² and R⁵ are each independently hydrogen or C₁-C₄-alkyl,
R³ and R⁴ are each independently hydrogen, optionally substituted C₁-C₄-alkyl or C₂-C₄-alkenyl,
for dyeing polyester material.

2. Use of a mixture according to claim 1, comprising compounds of the formula (I),
where
Z′ and Z″ are independently Cl or Br, and
R¹ and R′¹ are each independently hydrogen or unsubstituted C₁-C₄-alkyl.

3. Use of a mixture according to claim 1, comprising compounds of the formula (II), where X is Cl or Br, R³ and R⁴ are each independently hydrogen, C₂-C₄-alkenyl, unsubstituted C₁-C₄-alkyl or C₁-C₄-alkyl substituted by —OCOR, —CN and/or —COOR, where R is hydrogen or C₁-C₄-alkyl.

4. Use of a mixture according to claim 1, characterized in that it comprises a compound of the formula (III), (IV) and/or (V) 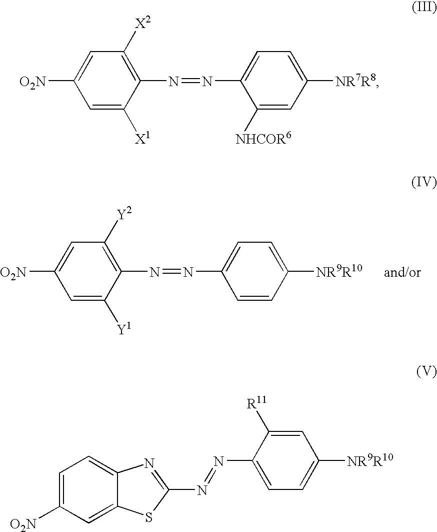
where
X¹ is halogen, especially Cl and Br or CN,
X² is halogen, especially Cl and Br, hydrogen, NO₂ or CN,
R⁶ is C₁-C₄-alkyl,
R⁷ and R⁸ are each independently hydrogen, unsubstituted or —OH—, —CN—, —OCOR—, —OCOC₆H₅—, —OCOO(C₁-C₄-alkyl)-, —COOR—, —OC₆H₅—, —C₆H₅— and/or C₁-C₄alkoxy-substituted C₁-C₄-alkyl or C₂-C₄-alkenyl, where R is hydrogen or C₁-C₄-alkyl,
Y¹ and Y² are each independently hydrogen or halogen, especially Cl and Br,
R⁹ and R¹⁰ are each independently hydrogen, unsubstituted or —OH—, —CN—, —OCOR—, —OCOC₆H₅— and/or C₁-C₄-alkoxy-substituted C₁-C₄-alkyl, where R is as defined above, or C₂-C₄-alkenyl,
R¹¹ is hydrogen, C₁-C₄-alkyl or C₁-C₄-alkoxy.

5. Mixture comprising at least one compound of the formula (I) 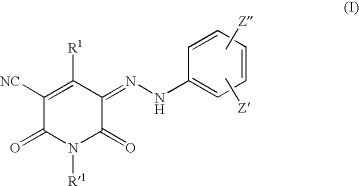
where
Z′ and Z″ are each independently hydrogen, halogen or CN, and
R¹ and R′¹ are each independently hydrogen or unsubstituted C₁-C₄-alkyl or C₁-C₄-alkyl substituted by —OH, —CN, —OCOR, —OCOC₆H₅, —OCOOR, —COOR, —OC₆H₅, —C₆H₅ and/or C₁-C₄-alkoxy,
and at least one compound of the formula (II) 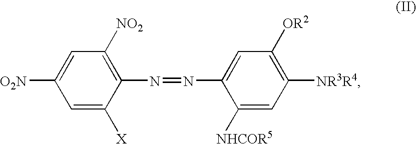
where
X is halogen, in particular Cl and Br or CN,
R² and R⁵ are each independently hydrogen or C₁-C₄-alkyl,
R³ and R⁴ are each independently hydrogen, optionally substituted C₁-C₄-alkyl or C₂-C₄-alkenyl,
for dyeing polyester material.

6. Mixture according to claim 5, comprising compounds of the formula (I), where
Z′ and Z″ are independently Cl or Br, and
R¹ and R′¹ are each independently hydrogen or unsubstituted C₁-C₄-alkyl.

7. Mixture according to claim 5, comprising compounds of the formula (II), where X is Cl or Br, R³ and R⁴ are each independently hydrogen, C₂-C₄-alkenyl, unsubstituted C₁-C₄-alkyl or C₁-C₄-alkyl substituted by —OCOR, —CN and/or —COOR, where R is hydrogen or C₁-C₄-alkyl.

8. Mixture according to claim 5, characterized in that it comprises a compound of the formula (III), (IV) and/or (V) 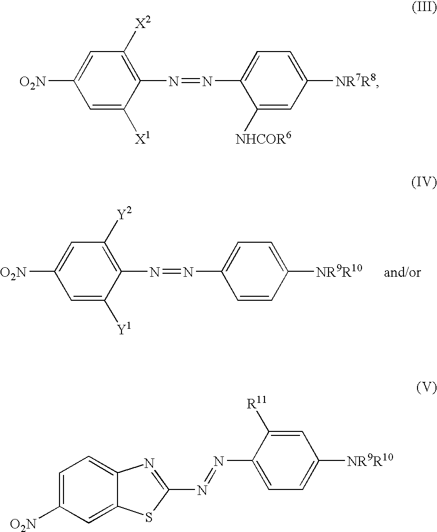
where
X¹ is halogen, especially Cl and Br or CN,
X² is halogen, especially Cl and Br, hydrogen, NO₂ or CN,
R⁶ is C₁-C₄-alkyl,
R⁷ and R⁸ are each independently hydrogen, unsubstituted or —OH—, —CN—, —OCOR—, —OCOC₆H₅—, —OCOO(C₁-C₄-alkyl)-, —COOR—, —OC₆H₅—, —C₆H₅— and/or C₁-C₄-alkoxy-substituted C₁-C₄-alkyl or C₂-C₄-alkenyl, where R is hydrogen or C₁-C₄-alkyl,
Y¹ and Y² are each independently hydrogen or halogen, especially Cl and Br,
R⁹ and R¹⁰ are each independently hydrogen, unsubstituted or —OH—, —CN—, —OCOR—, —OCOC₆H₅— and/or C₁-C₄-alkoxy-substituted C₁-C₄-alkyl, where R is as defined above, or C₂-C₄-alkenyl,
R¹¹ is hydrogen, C₁-C₄-alkyl or C₁-C₄-alkoxy.

9. Mixtures according to claim 5, comprising 1% to 99% by weight and especially 1% to 80% by weight of at least one compound of formula (I) and 1% to 99% by weight and especially 5% to 60% by weight of at least one compound of formula (II), based on the total amount of dye.

10. Dye formulation comprising
10% to 60% by weight of dye mixture according to claim 5, and
40% to 90% by weight of dispersant.

11. Process for producing the dye formulation according to claim 10, characterized in that the individual dyes of the dye mixture according to claim 1 are ground in water in the presence of a dispersant, subsequently mixed and optionally dried, or in that the dye mixture according to claim 5 is ground in water in the presence of a dispersant and optionally dried.

12. Use of the dye mixtures according to claim 5 for dyeing and printing hydrophobic synthetic materials or for mass coloration of hydrophobic synthetic materials.

13. Hydrophobic synthetic materials dyed or printed with dye mixtures according to claim 5.

14. Polyester materials dyed or printed using dye mixtures according to claim 1.
